(19) United States
(12) Patent Application Publication
(10) Pub. No.: US 2025/0244550 A1
(43) Pub. Date: Jul. 31, 2025

(54) SPLICE LINEAR INLINE DROP ENCLOSURE

(71) Applicant: viaPhoton, Inc., Aurora, IL (US)

(72) Inventors: Mark James SMRHA, Chicago, IL (US); Walter Mark HENDRIX, Dallas, TX (US); Nathan Eric BENTON, Dallas, TX (US); Jeffrey Earl JONES, SR., Stewartstown, PA (US)

(21) Appl. No.: 19/042,525

(22) Filed: Jan. 31, 2025

Related U.S. Application Data
(60) Provisional application No. 63/627,459, filed on Jan. 31, 2024.

(51) Int. Cl. G02B 6/44

(52) U.S. Cl. CPC G02B 6/44515; G02B 6/4454

(57) ABSTRACT

An apparatus comprises an inline drop enclosure configured to contain a trunk cable spliced at a length into a plurality of drop cables. The inline drop enclosure comprises a housing configured to receive a trunk cable at both a first end and a second end. The housing comprises a cover and a base. A splice tray is removably positioned within the housing. A plurality of cable guides is configured to route the trunk cable and the plurality of drop cables within the drop enclosure.

### CROSS-REFERENCE TO RELATED APPLICATIONS

This Application claims the benefit of U.S. Provisional Application Ser. No. 63/627,459, filed Jan. 31, 2024, which is hereby incorporated by reference for all purposes.

### BACKGROUND

Data centers rely on extensive cabling infrastructure to interconnect network equipment, including servers, switches, and storage devices. Managing fiber optic cables within these environments presents numerous challenges, particularly as data centers scale to accommodate increased bandwidth demands. Traditional cabling solutions often require individual cable runs between devices, which can lead to excessive cable congestion, inefficient space utilization, and increased complexity in routing and management. As more network components are deployed, the burden of installing and maintaining fiber optic connections grows, requiring careful planning to avoid excessive slack, signal degradation, and physical obstructions within cable pathways.

To address these challenges, modular fiber distribution systems and splice enclosures have been developed to streamline cable management. However, existing solutions often require extensive on-site splicing, which can be both labor-intensive and prone to installation errors. Improper splicing may lead to signal loss, increased attenuation, and network downtime. Additionally, conventional splice enclosures are frequently designed for fixed locations, limiting their adaptability in dynamic network environments. As a result, data center operators and network installers must carefully coordinate fiber deployments, often resorting to custom installations that increase overall costs and introduce potential failure points.

Despite advancements in pre-terminated fiber solutions and structured cabling methodologies, there remains a need for an efficient, scalable, and easily deployable inline fiber distribution system that reduces installation time and improves cable organization. Existing splice enclosures lack flexibility in accommodating multiple drop-off points along a trunk cable while maintaining a streamlined form factor for easy installation. The need for a system that integrates multiple fiber drops without the need for excessive on-site splicing or cable reconfiguration remains unmet, underscoring the demand for improved cable management solutions in modern data centers.

### SUMMARY

In general, in one aspect, one or more examples relate to an apparatus. The apparatus comprises an inline drop enclosure configured to contain a trunk cable spliced at a length into a plurality of drop cables. The inline drop enclosure comprises a housing configured to receive a trunk cable at both a first end and a second end. The housing comprises a cover and a base. A splice tray is removably positioned within the housing. A plurality of cable guides is configured to route the trunk cable and the plurality of drop cables within the drop enclosure.

In another aspect, one or more examples relate to a method for deploying a cable. A trunk cable, wound around a cable reel, is providing at a first location. The trunk cable comprises a set of inline drop enclosures configured to contain a trunk cable interspersedly into a plurality of drop cables along a length of the trunk cable. Each inline drop enclosure comprises: a housing configured to receive a trunk cable at both a first end and a second end, the housing comprising a cover and a base; a splice tray that is removably positioned within the housing; and a plurality of cable guides configured to route the trunk cable and the plurality of drop cables within the drop enclosure. The trunk cable is unwound from the cable hub to deploy the trunk cable to a second location. The drop cables are deployed to intermediate locations between the first location and the second location.

Other aspects of the invention will be apparent from the following description and the appended claims.

### BRIEF DESCRIPTION OF DRAWINGS

FIG. 1 shows a rack in accordance with one or more embodiments.

FIGS. 2A, 2B and 2C show an inline drop enclosure in accordance with one or more embodiments.

FIG. 3 shows an internal routing diagram of an inline drop enclosure in accordance with one or more embodiments.

FIG. 4 shows a use case example in accordance with one or more embodiments of the invention.

FIG. 5 shows a flow chart for deploying a cable in accordance with one or more embodiments.

Like elements in the various figures are denoted by like reference numerals for consistency.

### DETAILED DESCRIPTION

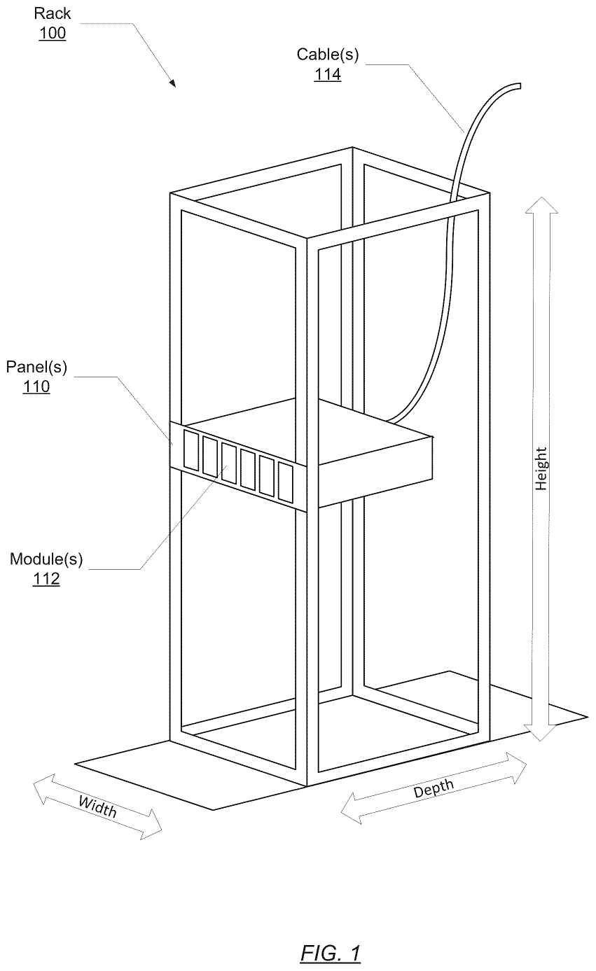

Turning to FIG. 1, a rack is shown in accordance with one or more embodiments. The rack (100) is a piece of telecommunications equipment that provides for the housing and organization of diverse telecommunication devices.

The outer dimensions of rack (100) align most network and server equipment. For example, rack width may measure 19 inches (48.26 cm) or 23 inches (58.42 cm) in width, standard measurements that are adhered to in the telecommunications industry. Other dimensions may be used, e.g., 21 inches, 23 inches, etc. The dimensions ensure that the rack can accommodate equipment with different form factors, such as 1 U, 2 U, or larger units, where “U” represents a standard rack unit of measure equal to 1.75 inches in height.

The rack (100) may include a series of uniformly spaced vertical mounting slots, located on both the front and rear, to facilitate the arrangement and mounting of various telecommunication devices and components. The slots serve as attachment points for mounting the panel(s) (110). The rack (100) may further be equipped with additional features such as ventilation openings and cable management.

Panel(s) (110) are components that mount within the rack (100) to organize, secure, and provide access to connective hardware. The panel may be constructed from materials like steel or aluminum that can support the weight of the modules and withstand the physical demands of a data center environment.

Panel(s) (110) are formed with standardized form factors for compatibility with the mounting slots of the rack (100). For example, panel(s) (110) may include standardized mounting points to align with rack units, a layout that supports the intended cable or connector density, and provisions for labeling and user accessibility.

The panel(s) (110) may be equipped with one or more module(s) (112) to secure the fibers using ports, connector adapters, connectors, etc. Module(s) (112) are prefabricated units or sub-assemblies designed for quick installation into the rack (100). The module(s) (112) may include electronic components and/or optical components, such as optical connectors, optical fibers, switches, routers, or patches. The module(s) (112) may include features for splicing, cable management, and security.

Each module(s) (112) is designed to contain a specific number of optical connectors, optimizing space utilization within the rack mount to support high fiber densities. The connectors may be an industry-standard connector such as a standard connector (SC), Lucent connector (LC), or Multi-fiber Termination Push-on connector (MTP), depending on the network requirements. For example, each module(s) (112) may support fiber densities of 144 fibers per module, 288 fibers per module, and/or 576 fibers per module, as well as other suitable densities.

The module(s) (112) may have multiple widths, such that a varying number of modules may be housed within the panel(s) (110). The module(s) (112) may be sized to fit twelve (12) modules in the panel(s) (110), however other sizes—e.g., 2, 3, 4, 6, 8—are also contemplated.

The modules can be interconnected via cable(s) (114). Cable(s) (114) may be fiber optic cables that carry data signals between different network devices and components. Cable(s) (114) are routed through the data center infrastructure, connecting panels, modules, and external devices. These cables may include a core, cladding, and protective coating, which ensure the integrity of the data signal. The cables may be color-coded to facilitate identification during installation and maintenance. Cable(s) (114) can be single-mode or multi-mode, depending on the network requirements.

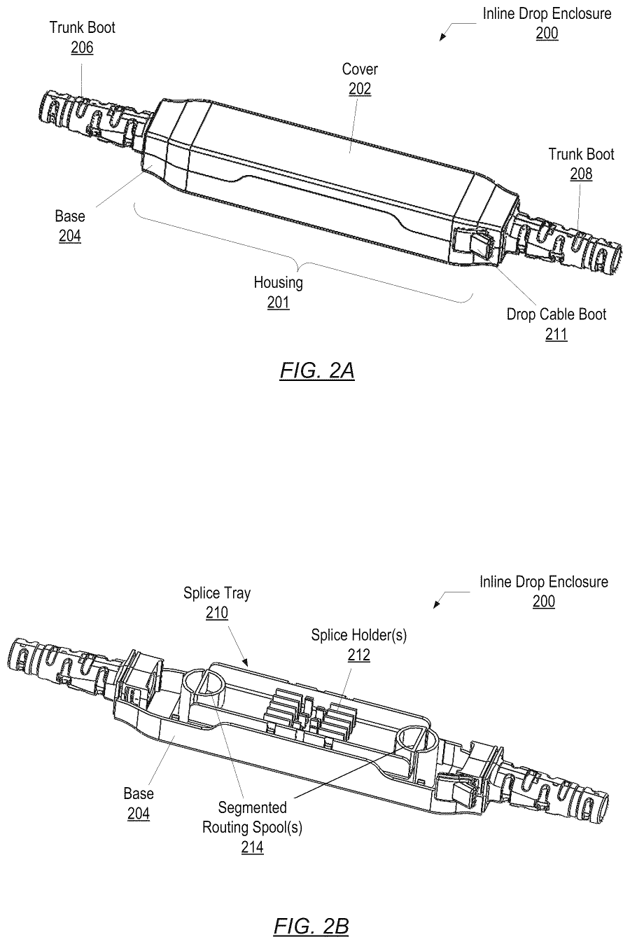

Referring now to FIGS. 2A, 2B and 2C, an inline drop enclosure is shown according to illustrative embodiments. The inline drop enclosure (200) can be spliced into a cable, such as cable(s) (114) of FIG. 1.

Referring specifically to FIG. 2A, the inline drop enclosure (200) comprises a housing (201) that includes a cover (202) and a base (204). The housing (201) defines an interior cavity that contains cable management structures, which are not visible in the perspective view. The cover (202) is positioned over the base (204), enclosing the internal components of the inline drop enclosure (200). The housing (201) is elongated and configured to receive a trunk cable at both a first and a second end.

A pair of trunk boots (206, 208) is mounted at opposite ends of the inline drop enclosure (200). Each trunk boot (206, 208) is secured to the housing (201) and serves as a strain relief mechanism for a trunk cable passing through the inline drop enclosure (200). Positioned on one side of the housing (201), a drop cable boot (211) extends outward, providing an exit point for at least one drop cable that is spliced from the trunk cable within the inline drop enclosure (200). The trunk boots (206, 208) and the drop cable boot (211) are provided to maintain cable strain relief.

The inline drop enclosure (200) is configured for integration within a cable pathway, allowing multiple units to be positioned along a trunk cable at spaced intervals. When deployed, the trunk cable passes through the trunk boots (206, 208), with selected fibers being accessed within the housing (201) and routed to the drop cable boot (211) for connection to other equipment.

In FIG. 2B, the inline drop enclosure (200) is shown with the cover removed, exposing the internal components housed within the base (204). The splice tray (210) is positioned within the enclosure and supports multiple splice holders (212) arranged along its length. The splice holders (212) are configured to retain spliced fiber connections, securing individual fiber segments after separation from the trunk cable. The splice tray (210) is designed for removal, facilitating access to the splice holders (212) for installation or maintenance.

Segmented routing spool(s) (214) are mounted within the base (204) at opposite ends of the splice tray (210). Each segmented routing spool(s) (214) comprises a first segment that remains fixed to the base (204) and a second segment that is attached to the splice tray (210). When the splice tray (210) is positioned within the housing, the second segment of each segmented routing spool(s) (214) is aligned proximate to the first segment, forming a continuous fiber routing structure that directs cable pathways and maintains bend radius control.

The positioning of the segmented routing spool(s) (214) allows the trunk cable and drop cables to be routed in an organized manner while minimizing stress on the fiber connections. The overall arrangement of components ensures that fiber management is maintained within the housing while providing designated routing paths for both trunk and drop cables.

In FIG. 2B, the inline drop enclosure (200) is shown with both the cover and splice tray removed, exposing the internal components housed within the base (204). The base of the inline drop enclosure provides structural support for internal fiber routing and splicing components. Stand-off spools (218) are positioned along the interior surface of the base, elevating the splice tray when installed to allow for controlled fiber management. Spool segments (220) are arranged at opposite ends of the base, forming defined pathways for routing trunk and drop fibers while maintaining proper bend radius.

Alignment tabs (215) extend from the base, facilitating alignment of the base with the cover. Tray tabs (216) are integrated Along the sidewalls of the base to provide additional stabilization for the splice tray. Boot slots (222) are formed at each end of the enclosure to retain trunk boots and drop cable boots, securing cables entering and exiting the enclosure.

Recesses (226) are integrated into the trunk boot to accommodate a split trunk boot, allowing the boot halves to be secured together during installation/splicing, such as with a zip tie. Gaps (224) in the trunk boot allow for controlled flexing of the boot retention areas, maintaining strain relief when securing cables. Crimp windows (228) in the trunk boot are positioned near the trunk cable entry points, facilitating crimping operations to secure fiber bundles within the boot.

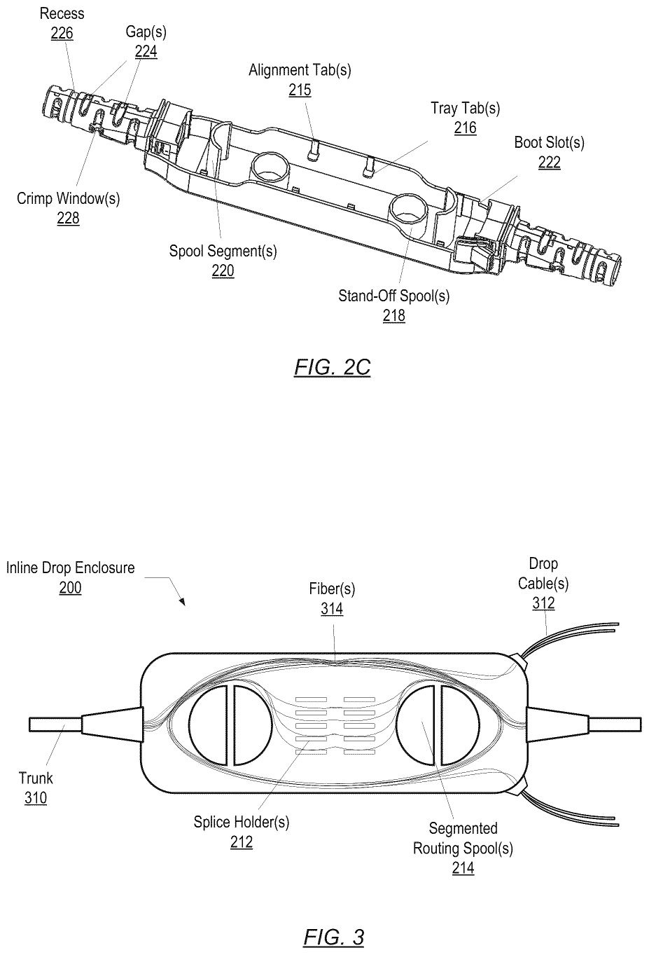

Referring now to FIG. 3, a top-down schematic of the inline drop enclosure illustrating the fiber pathways is shown according to illustrative embodiments.

The inline drop enclosure (200) houses a trunk cable (310) that enters from one end and exits from the opposite end, with fibers (314) routed within the enclosure. The trunk cable (310) contains multiple fibers (314), some of which are accessed and redirected toward drop cables (312). The drop cables (312) exit the enclosure at designated locations along its length.

Segmented routing spool(s) (214) are positioned on either side of the enclosure, defining curved pathways that manage fiber routing while maintaining bend radius control. Splice holders (212) are centrally located within the enclosure, securing individual fiber splices between the trunk cable (310) and the drop cables (312). The fibers (314) are routed around the segmented routing spool(s) (214) before being secured within the splice holders (212).

The trunk cable (310) continues through the inline drop enclosure (200), allowing for additional enclosures to be spliced along its length. The arrangement of the internal components ensures organized fiber management, facilitating fiber breakout and redirection while minimizing stress on the fiber connections.

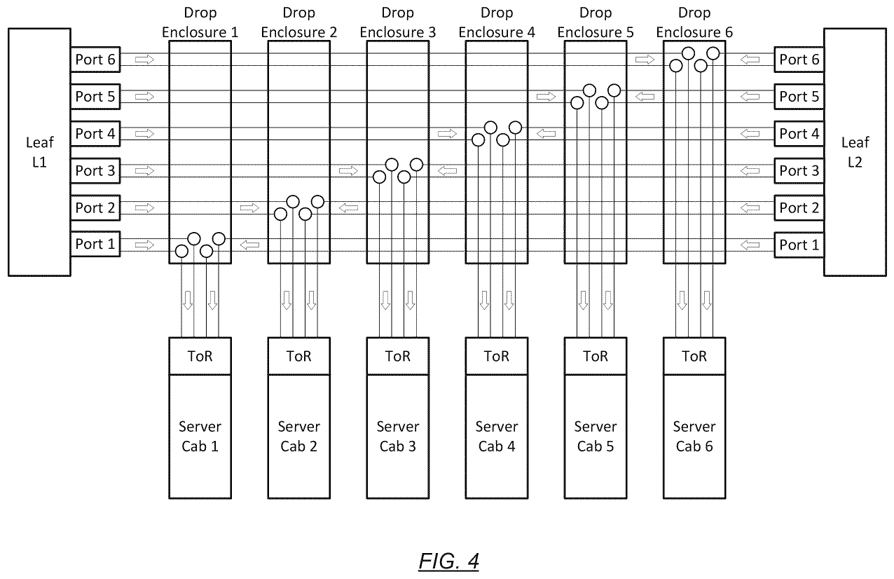

Referring now to FIG. 4, a use case diagram showing six different drop enclosures interspersedly spliced along a single trunk cable. Fiber paths are managed within each drop enclosure, maintaining signal integrity, and ensuring that the correct fibers are directed to the appropriate network equipment.

A single trunk cable extends between two leaf switches, Leaf L1 and Leaf L2. Six inline drop enclosures are interspersedly spliced along the trunk cable. Each drop enclosure provides fiber access points along the trunk cable, enabling connectivity between the leaf switches and top-of-rack (ToR) switches housed within server cabinets. Each ToR switch in the server cabinets serves as an aggregation point for network traffic, enabling data exchange between servers and other network infrastructure.

The trunk cable originates at Leaf L1, where six individual ports transmit data along dedicated fiber paths. These fibers traverse through the trunk cable, reaching Drop Enclosure 1, where selected fibers are broken out and routed to the ToR switch in Server Cabinet 1.

The remaining fibers continue along the trunk cable to Drop Enclosure 2, where another subset of fibers is accessed and connected to the ToR switch in Server Cabinet 2. This pattern continues sequentially through Drop Enclosures 3, 4, 5, and 6, each facilitating fiber splices that connect to corresponding ToR switches in Server Cabinets 3, 4, 5, and 6.

After the final breakout at Drop Enclosure 6, the remaining trunk fibers continue toward Leaf L2. The leaf switch at Leaf L2 receives the fiber connections from the trunk, providing bidirectional communication between Leaf L1 and the distributed ToR switches. The trunk cable remains continuous along its length, with each drop enclosure introducing access points without disrupting the integrity of the remaining fiber connections.

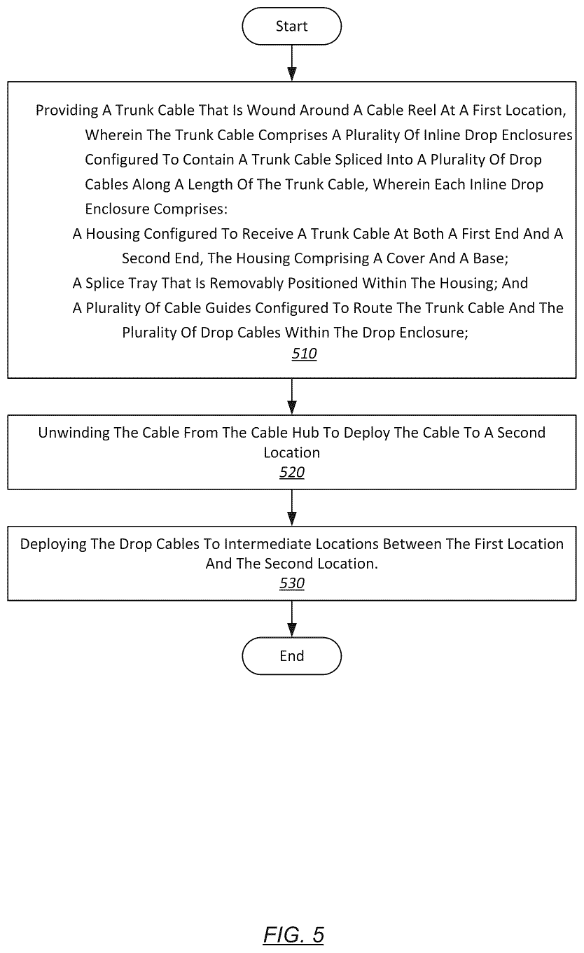

Turning now to FIG. 5 a flow chart for deploying a cable is shown in accordance with one or more embodiments.

The flowchart illustrates a method for deploying a trunk cable integrated with multiple inline drop enclosures, facilitating fiber breakout at intermediate locations along the trunk's length.

At step 510, a trunk cable is provided, wound around a cable reel at a first location. The trunk cable includes a set of inline drop enclosures, each housing a spliced connection between designated fibers of the trunk cable and corresponding drop cables. Each inline drop enclosure consists of a housing with a cover and a base, a removable splice tray, and multiple cable guides that organize and secure fiber routing. The trunk cable is pre-assembled with these drop enclosures at designated points along its length, ensuring that specific fibers are available for distribution at each drop location. The cable is prepared for deployment, allowing for seamless integration within a structured network infrastructure.

At step 520, the trunk cable is unwound from the cable hub to deploy the cable to a second location. As the cable is pulled, the inline drop enclosures remain securely attached along the trunk, maintaining alignment with pre-determined fiber drop points. The unwinding process ensures that the trunk cable reaches its intended routing path while preserving fiber integrity within the inline drop enclosures. Strain relief mechanisms, such as trunk boots secured within boot slots, help protect the cable from excessive tension during deployment. The deployment process enables the trunk cable to span between two terminal locations while supporting fiber access at intermediate points.

At step 530, drop cables are deployed to intermediate locations between the first and second locations. Each inline drop enclosure provides an exit point for designated fibers, which are routed through drop cable boots for connection to network equipment. The segmented routing spools within the inline drop enclosure guide the fiber paths, preventing excessive bending and ensuring proper fiber management. The spliced fibers within the splice tray are secured using splice holders, maintaining connectivity while minimizing signal loss. As the deployment progresses, each drop enclosure enables fiber breakout at its designated location, providing structured connectivity for top-of-rack switches, access nodes, or other network components.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, “or” is an “inclusive or” and, as such includes “and.” Further, items joined by an or may include any combination of the items with any number of each item unless expressly stated otherwise.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of keyword extraction using tags and n-grams. The various elements, systems, components, and steps shown in the figures may be omitted, repeated, combined, and/or altered as shown from the figures. Accordingly, the scope of the present disclosure should not be considered limited to the specific arrangements shown in the figures.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus comprising:
an inline drop enclosure configured to contain a trunk cable spliced at a length into a plurality of drop cables wherein the inline drop enclosure comprises:
a housing configured to receive a trunk cable at both a first end and a second end, the housing comprising a cover and a base;
a splice tray that is removably positioned within the housing; and
a plurality of cable guides configured to route the trunk cable and the plurality of drop cables within the drop enclosure.

2. The apparatus of claim 1, wherein the plurality of cable guides further comprises:
a pair of segmented routing spools mounted at opposite ends of the inline drop enclosure, each of the spools comprising:
a first segment that is attached to the base within an interior of the housing; and
a second segment that is attached to the splice tray and positioned proximate to the first segment when the splice tray is positioned within the housing; and
a set of splice holders attached to the splice tray between the respective second segments of the pair of segmented routing spools.

3. The apparatus of claim 1, wherein the plurality of cable guides further comprises:
a set of standoff spools attached to the base within an interior of the housing; and
a set to tray tabs attached to the base along sidewall of the housing;
wherein the set of standoff spools and the set of tray tabs support the splice tray at an offset from the base when splice tray is positioned within the housing.

4. The apparatus of claim 1, further comprising:
a pair of trunk boots mounted to the housing at opposite ends of the inline drop enclosure; and
at least one drop cable boot mounted to the housing.

5. The apparatus of claim 4, wherein the housing further comprises:
a set of boot slots configured to retain the pair of trunk boots and the at least one drop cable boot.

6. The apparatus of claim 4, further comprising:
a trunk cable, supported by the pair of trunk boots, comprising a plurality of fibers; and
at least one drop cable supported by the at least one drop cable boot, each drop cable comprising at least one fiber form the plurality of fibers, broken out from the trunk cable within the inline drop enclosure.

7. The apparatus of claim 1, wherein the inline drop enclosure is one of a set of inline drop enclosures, the apparatus further comprising:
a trunk cable, wherein the set of inline drop enclosures is interspersedly spliced along a length of the trunk cable.

8. The apparatus of claim 7, wherein the trunk cable and the set of inline drop enclosures are wound around a spool.

9. A method for deploying a cable, the method comprising:
providing a trunk cable that is wound around a cable reel at a first location, wherein the trunk cable comprises a set of inline drop enclosures that are configured to contain the trunk cable spliced into a plurality of drop cables along a length of the trunk cable, wherein each inline drop enclosure comprises:
a housing configured to receive a trunk cable at both a first end and a second end, the housing comprising a cover and a base;
a splice tray that is removably positioned within the housing; and
a plurality of cable guides configured to route the trunk cable and the plurality of drop cables within the drop enclosure;
unwinding the cable from the cable hub to deploy the cable to a second location; and
deploying the drop cables to intermediate locations between the first location and the second location.

10. The method of claim 9, wherein the plurality of inline drop enclosures is interspersedly positioned along the trunk cable, the method further comprising:
splicing designated fibers within each inline drop enclosure to form fiber drop connections along the trunk cable.

11. The method of claim 9, further comprising:
securing the trunk cable and the plurality of inline drop enclosures to a spool prior to deployment; and
unwinding the spool to facilitate controlled deployment of the trunk cable and inline drop enclosures along a designated cable pathway.

12. The method of claim 9, further comprising:
aligning each inline drop enclosure along the cable pathway so that drop cables exit at predetermined intervals; and
securing each drop cable to an intermediate location to establish fiber connections between the trunk cable and network equipment.

13. The method of claim 9, wherein the plurality of cable guides further comprises:
a pair of segmented routing spools mounted at opposite ends of the inline drop enclosure, each of the spools comprising:
a first segment that is attached to the base within an interior of the housing; and
a second segment that is attached to the splice tray and positioned proximate to the first segment when the splice tray is positioned within the housing; and
a set of splice holders attached to the splice tray between the respective second segments of the pair of segmented routing spools.

14. The method of claim 9, wherein the plurality of cable guides further comprises:
a set of standoff spools attached to the base within an interior of the housing; and
a set to tray tabs attached to the base along sidewall of the housing;
wherein the set of standoff spools and the set of tray tabs support the splice tray at an offset from the base when splice tray is positioned within the housing.

15. The method of claim 9, further comprising:
a pair of trunk boots mounted to the housing at opposite ends of the inline drop enclosure; and
at least one drop cable boot mounted to the housing.

16. The method of claim 9, wherein the housing further comprises:
a set of boot slots configured to retain the pair of trunk boots and the at least one drop cable boot.

17. An inline drop enclosure configured to contain a trunk cable spliced at a length into a plurality of drop cables wherein the inline drop enclosure comprises:
a housing configured to receive a trunk cable at both a first end and a second end, the housing comprising a cover and a base;
a splice tray that is removably positioned within the housing; and
a plurality of cable guides configured to route the trunk cable and the plurality of drop cables within the drop enclosure.

18. The inline drop enclosure of claim 17, wherein the plurality of cable guides further comprises:
a pair of segmented routing spools mounted at opposite ends of the inline drop enclosure, each of the spools comprising:
a first segment that is attached to the base within an interior of the housing; and
a second segment that is attached to the splice tray and positioned proximate to the first segment when the splice tray is positioned within the housing; and
a set of splice holders attached to the splice tray between the respective second segments of the pair of segmented routing spools.

19. The inline drop enclosure of claim 17, wherein the plurality of cable guides further comprises:
a set of standoff spools attached to the base within an interior of the housing; and
a set to tray tabs attached to the base along sidewall of the housing;
wherein the set of standoff spools and the set of tray tabs support the splice tray at an offset from the base when splice tray is positioned within the housing.

20. The inline drop enclosure of claim 17, further comprising:
a pair of trunk boots mounted to the housing at opposite ends of the inline drop enclosure; and
at least one drop cable boot mounted to the housing.
